(19) United States
(12) Patent Application Publication
(10) Pub. No.: US 2026/0363955 A1
(43) Pub. Date: Nov. 19, 2026

(54) ADAPTER AND SYSTEM COMPRISING A CONTAINER WITH ADAPTER

(71) Applicant: sfm medical devices GmbH, Wächtersbach (DE)

(72) Inventor: Vitali KEIL, Wartmannsroth (DE)

(73) Assignee: sfm medical devices GmbH, Wächtersbach (DE)

(21) Appl. No.: 19/675,608

(22) Filed: May 13, 2026

(30) Foreign Application Priority Data
May 14, 2025 (DE) 10 2025 118 648.0

(51) Int. Cl. A61J 1/20; A61J 1/14

(52) U.S. Cl. CPC A61J 1/2048; A61J 1/1406; A61J 1/201

(57) ABSTRACT

A system including a bottle (12) and an adapter (100) which is prevented from rotation relative to the bottle.

### CROSS-REFERENCE TO RELATED APPLICATIONS

This application claims priority to German patent application number 10 2025 118 648.0, filed on May 14, 2025. The content of this application is incorporated herein by reference in its entirety.

### BACKGROUND OF THE INVENTION

The invention relates to a system comprising
a first container such as a vial comprising an opening, a stopper placed inside the opening, an in particular flange-like or bead-like rim enclosing the opening, and preferably a stopper cap enclosing the rim and covering the stopper on the rim side, and
an adapter comprising a wall designed to extend along the opening when the adapter is associated with the first container, wherein a cannula body designed to pierce the stopper extends from one side of the wall, and a connecting section for a second container such as a syringe body, connected to the cannula body in fluid-carrying manner, extends from its other side.

In particular, the subject matter of the invention is a system comprising
a bottle such as a vial comprising a bottleneck with an opening, a stopper placed inside the opening, an in particular flange-like or bead-like rim enclosing the opening, a stopper cap enclosing the rim and covering the stopper on the rim side, and
an adapter comprising a hollow-cylindrical peripheral wall enclosing and/or gripping around the rim of the opening of the bottle, a wall extending along the stopper cap and from the peripheral wall vertical to the longitudinal axis of the adapter when the peripheral wall is enclosing the rim, from one side of which wall extends a cannula body designed to pierce the stopper and from its other side extends a connecting section for a container such as a syringe body, connected to the cannula body in fluid-carrying manner.

The subject matter of the invention is an adapter for transferring a substance from a first container such as a vial having an opening with a rim enclosing it, into a second container such as a syringe body, comprising a wall designed to extend along the opening when the adapter is associated with the bottle, wherein a cannula body extends from one side of the wall, and a hollow-cylindrical section in communication with the cannula body extends from the other side and is connectable to the second container; wherein the opening of the first container is sealable using a stopper which is pierceable by the cannula body; and wherein the cannula body has a contact area in which the cannula body is sealingly enclosed by the stopper after piercing it.

In particular, it is provided that the adapter has a hollow-cylindrical peripheral wall enclosing and/or gripping around the rim of the opening of the bottle, which peripheral wall extends from the wall extending along the opening and vertical to the longitudinal axis of the adapter.

There is also the possibility that engaging elements such as engaging fingers, which grip around the all-round rim of the bottle when the adapter is connected to the bottle, extend indirectly or directly from the wall for a holding connection between the adapter and the bottle/first container.

Irrespectively of this, the cannula body should extend with its longitudinal axis vertical to the one side of the wall, and the hollow-cylindrical section should extend with its longitudinal axis vertical to the other side of the wall.

The hollow-cylindrical section is in particular an element which is screwable to a syringe, bag or tube, for example. The hollow-cylindrical section is therefore preferably designed as a luer cone with lobes that engage in a thread.

An adapter, or a system comprising a bottle such as a vial and an adapter, is known for example from EP 3 454 818 B1. The adapter has in this case a cannula body, also referred to as a spike, that passes through a closing stopper of the vial as soon as the adapter has engaged with the vial.

The spike extending from a wall vertical to the adapter longitudinal axis merges into a hollow-cylindrical section such as a female luer cone extending from the opposite side, which section is connected for example to a syringe for removing a medication from the vial.

For connection of the adapter to the bottle, a peripheral wall can extend from the wall with the spike and with the opposite connecting section such as a luer cone and has projections which grip around the bead-like rim of the vial when the adapter is enclosed. A type of engagement is achieved as a result. Regardless of this, however, the disadvantage may arise that the adapter is seated loosely on the vial such that detachment of the adapter from the vial is possible.

There is also the disadvantage that the adapter is rotated relative to the vial when a syringe or any other container is connected to the hollow-cylindrical section, i.e. a torque is generated. The user then has to secure the adapter using the same hand that is holding the vial. This is often difficult with large-volume bottles. The same problem occurs with small vessels which make it difficult to hold the adapter.

### SUMMARY OF THE INVENTION

The object underlying the present invention is to develop a system comprising a first container such as a bottle and an adapter of the previously described type, and an adapter such that it is assured that the adapter is not co-rotated or basically not co-rotated due to the effect of a torque when it is connected to the first container such as a bottle.

According to a further aspect, wobbling of the adapter relative to the bottle should be substantially avoided regardless of the flexibility of the stopper.

To solve at least one of the aspects of the invention, an adapter is provided for transferring a substance from a first container such as a vial having an opening with a rim enclosing it, into a second container such as a syringe body, comprising a wall designed to extend along the opening when the adapter is associated with the first container, wherein a cannula body extends from one side of the wall, and a hollow-cylindrical section in communication with the cannula body extends from the other side and is connectable to the second container; wherein the opening of the first container is sealable using a stopper which is pierceable by the cannula body; and wherein the cannula body has a contact area in which the cannula body is sealingly enclosed by the stopper after piercing it, characterized in that the adapter is designed for rotation-preventing connection to the first container.

In particular it is provided, for solving at least one of the aspects of the invention, that when the adapter is connected to the first container such as a bottle and/or when the adapter is covering the opening of the first container, the adapter is connected to the stopper and/or to a stopper cap enclosing the opening of the first container in a manner preventing rotation, or the adapter is prevented from rotation relative to the first container.

Prevented from rotation means that when a torque is acting on the adapter and the first container is being held, there is no relative rotational movement between the adapter and the first container apart from a possible elasticity of the stopper.

In particular, it is provided for solving the object that at least one preferably wedge-like or pointed projection, which penetrates into the stopper when the adapter is connected to the first container, in particular when the adapter is enclosing the rim of the first container or gripping around it, extends from the adapter, in particular from the wall. This prevents their rotational movement relative to one another when the first container is fixed, such as held.

Preferably, the invention provides that the adapter has several wedge-like or pointed projections which are arranged in particular equidistantly to one another, wherein the projections extend preferably from a circle which preferably encloses the cannula body coaxially.

The pointed projections should extend here along the cannula body, preferably parallel or approximately parallel thereto, and from the wall.

The at least one projection may have in particular a cylindrical geometry with a tip area tapering at the end.

It is however also possible that the at least one projection has edges extending in the longitudinal direction, and in particular has a multiple-edge geometry in the longitudinal direction with a tip area tapering at the end.

An alternative or supplementary proposal for a solution in which the cannula body has a contact area sealed by the stopper when the adapter is connected to, in particular enclosing, the first container, in the following also referred to only as the bottle, is characterized in that the contact area diverges at least in some areas from a circular geometry on the peripheral side in a plane vertical to the longitudinal axis of the cannula body.

Preferably, it is provided that ridge-like projections, whose peripheral rims at a distance from the cannula are inclined relative to the longitudinal axis of the cannula body, extend from the cannula body, wherein an area close to the cannula tip has a shorter distance from the longitudinal axis of the cannula body than an area at a distance from the cannula tip.

A further alternative or supplementary proposal for a solution is characterized in that the adapter has, in its area interacting with the stopper cap, engaging elements such as ridge-like projections in the longitudinal direction of the adapter, and the stopper cap has in its area interacting with the adapter, such as the peripheral surface, engaging receptacles adapted in some sections, such as channel-like depressions extending in the longitudinal direction of the bottle, or vice versa.

There is also the possibility that the adapter has at least one shaping or impressing projection designed to form, when the stopper cap is gripped, a corresponding shape therein, wherein the shaping or impressing projection engages in that shape when the adapter is enclosing the stopper cap.

This too results in rotation prevention, i.e. rotation of the adapter and bottle relative to one another is ruled out as long as one of the elements is fixed.

It may also be provided that the adapter has at least one projection designed, when the stopper cap is connected to the adapter, in particular enclosed by it, to be shaped by the stopper cap such that the rim area of the stopper cap extending along the stopper positively engages in the projection.

The system is also characterized in particular in that the stopper cap has a circular geometry on the peripheral side in a plane vertical to the longitudinal axis of the bottle and over its entire height, and/or that at least the cannula body has a circular geometry in the contact area enclosed by the stopper and contacting the latter over the entire length of the contact area in a plane vertical to the longitudinal axis of the cannula body.

The teachings in accordance with the invention enable an adapter to be connected to a bottle such as a vial without any problem, in order to then connect a syringe body, tube or bag to the adapter, which are connected to the adapter after making a rotational movement, such as by means of a screw connection or rotatable valve connection. This may be in particular a luer lock connection, without the invention being limited by that.

Due to the bottle being prevented from rotation relative to the adapter, a rotational movement is performable without any problem that does not lead to a co-rotation of the adapter when the connection is made and when the bottle is held by the connecting section in communication with the cannula body, enabling a secure connection to be made.

Due to the at least one element penetrating into the stopper, such as the projection extending from the adapter, which may have in particular a pointed or wedge shape, the clamping effect for the stopper cap, usually referred to as the crimped cap or flanged cap, of the container is also increased.

The cause of this is that due to the penetration of the projection into the stopper, in addition to the penetration of the cannula body, also referred to as the spike, the stopper consisting of elastic material is deformed in the direction of the bottom of the first container, such as a vial bottom, and after penetration of the cannula body and of the at least one projection attempts to move back into the initial position, i.e. into the position prior to penetration of the cannula body and of the at least one projection, wherein the adapter is also moved against the piercing direction due to the sealing and adhesive enclosing of the cannula body and of the at least one projection, with the result that the clamping effect of the sections of the adapter is increased in those areas of the stopper cap in which the sections grip around them.

The tilting movement of the adapter relative to the vial is furthermore reduced or even ruled out in particular when several projections penetrate into the stopper for rotation prevention.

An adapter for transferring a substance from a first container such as a vial having an opening with a rim enclosing it, into a second container such as a syringe body, comprising a wall designed to extend along the opening when the adapter is associated with the first container; a cannula body extending from one side of the wall and a hollow-cylindrical section in communication with the cannula body connectable to the second container, wherein the opening of the first container is sealable using a stopper which is pierceable by the cannula body and wherein the cannula body has a contact area in which the cannula body is sealingly enclosed by the stopper after piercing it, is characterized in particular in that the adapter is prevented from rotation relative to the first container when the wall of the adapter is covering the opening of the first container.

The adapter is designed for rotation-preventing connection to the first container. A back-and-forth movement relative to one another about the longitudinal axis of the container and of the adapter is prevented.

The adapter and the first container effectively form an integral unit.

In particular, the invention also relates to an adapter for transferring a substance from a first container such as a vial having an opening with a rim enclosing it, into a second container such as a syringe body, comprising a peripheral wall suitable for enclosing the first container, along which and coaxially to which extends a cannula body enclosed at least in some sections, and a hollow-cylindrical section in communication with the cannula body and connectable to the second container, wherein the cannula body extends with its longitudinal axis vertical to a side of a wall transverse to the peripheral wall and the hollow-cylindrical section extends with its longitudinal axis vertical to the other side of the wall; wherein the opening of the first container is sealable using a stopper which is pierceable by the cannula body; wherein the cannula body has a contact area in which the cannula body is sealingly enclosed by the stopper after piercing it; and wherein the adapter is in particular characterized in that the adapter is connected to the stopper and/or to a stopper cap enclosing the rim of the first container in a manner preventing rotation when the adapter is enclosing the rim of the first container, or the adapter is prevented from rotation relative to the bottle.

It is here in particular provided that at least one projection, for example wedge-like or pointed, which has penetrated into the stopper when the adapter is covering the opening and/or is enclosing or gripping around the rim of the bottle, extends from the adapter, in particular from the wall.

According to a further proposal, the adapter is characterized in that the at least one projection has a cylindrical geometry with a tip area tapering at the end or at least edges extending in the longitudinal direction, and in particular has a multiple-edge geometry in the longitudinal direction with a tip area tapering at the end.

There is also the possibility that ridge-like projections, whose peripheral rims at a distance from the cannula are inclined relative to the longitudinal axis of the cannula body, extend from the cannula body, wherein an area close to the cannula tip has a shorter distance from the longitudinal axis of the cannula than an area at a distance from the cannula tip. The projections penetrate into the stopper of the vial such that rotation is prevented.

The invention may also be characterized in that the stopper cap enclosing the rim of the first container has a circular geometry on the peripheral side in a plane vertical to the longitudinal axis of the bottle and over its entire height and/or in that at least the cannula body has a circular geometry in a plane vertical to the longitudinal axis of the cannula body in the contact area enclosed by the stopper and contacting the latter over the entire length of the contact area.

In particular, it should be the case for the system and for the adapter that the stopper cap on the peripheral side and/or at least the cannula body in its contact area sealed by the stopper have a geometry rotationally symmetrical to the longitudinal axis of the adapter.

For rotation prevention, it may be alternatively or supplementarily provided that the cannula body diverges in its cross-section from a circular geometry in the area enclosed by the stopper.

The area sealingly enclosed by the stopper diverges from a rotational symmetry.

The subject matter of the invention is also a method for removing a medium from a first container such as a vial with an opening closed by a stopper and using an adapter with a wall vertical to its longitudinal axis, from one side of which wall extends a cannula body piercing the stopper and from whose opposite side extends a connecting section for a second container such as a syringe body, wherein the method is characterized by the method steps:
a) piercing of the stopper by means of the cannula body,
b) rotation-preventing connection between the adapter and the first container,
c) connection of the second container to the connecting section,
d) exerting a torque on the connecting section by means of the second container with simultaneous fixing of the first container.

The method steps a) and b) and/or the method steps c) and d) can be performed simultaneously here.

In particular, an adapter as has been previously described is used.

Further details, advantages and features of the invention can be gathered not only from the claims and in the features to be found therein, but also from the preferred examples shown in the following description.

### BRIEF DESCRIPTION OF THE DRAWINGS

The drawing shows in:

FIG. 1 an adapter according to the prior art connected to a container,

FIG. 2 the adapter according to FIG. 1 in a perspective view,

FIG. 3 a view of the adapter in the direction of a wall facing the container,

FIG. 4 a first embodiment of an adapter in accordance with the invention enclosing the opening of a container,

FIG. 5 a perspective view of the adapter according to FIG. 4,

FIG. 6 a view of the adapter according to FIGS. 4 and 5 in the direction of its wall facing the container,

FIG. 7 a second embodiment of an adapter in accordance with the invention enclosing the opening of a container,

FIG. 8 a perspective view of the adapter according to FIG. 7,

FIG. 9 a view of the adapter according to FIGS. 7 and 8 in the direction of the wall facing the container,

FIG. 10 a third embodiment of an adapter in accordance with the invention enclosing an opening of a bottle,

FIG. 11 the adapter according to FIG. 10 in a perspective view,

FIG. 12 a view of the adapter according to FIGS. 10 and 11 in the direction of its wall facing the container,

FIG. 13 a further embodiment of an adapter in accordance with the invention enclosing the opening of a bottle,

FIG. 14 the adapter according to FIG. 13 in a perspective view,

FIG. 15 a view of the adapter according to FIGS. 13 and 14 in the direction of its wall facing the container,

FIG. 16 a section of the bottle with stopper cap according to FIG. 13,

FIG. 17 an alternative to the embodiment according to FIG. 13,

FIG. 18 a further embodiment of an adapter in accordance with the invention enclosing the opening of a bottle,

FIG. 19 the adapter according to FIG. 18 in a perspective view,

FIG. 20 a section from FIG. 18,

FIG. 21 a view of the adapter according to FIGS. 18 and 19 in the direction of its wall facing the container,

FIG. 22 a section of the bottle with stopper cap from FIG. 18,

FIG. 23 a further embodiment of an adapter in accordance with the invention enclosing the opening of a bottle,

FIG. 24 a detail of FIG. 23,

FIG. 25 a section of bottle with stopper cap from FIG. 23,

FIG. 26 a further embodiment of a system with adapter and stopper cap of a container,

FIGS. 27a-27b an illustration of the principle of a further embodiment of an adapter and

FIGS. 28a-28b a further illustration of the principle of a further embodiment of an adapter.

### DETAILED DESCRIPTION OF THE INVENTION

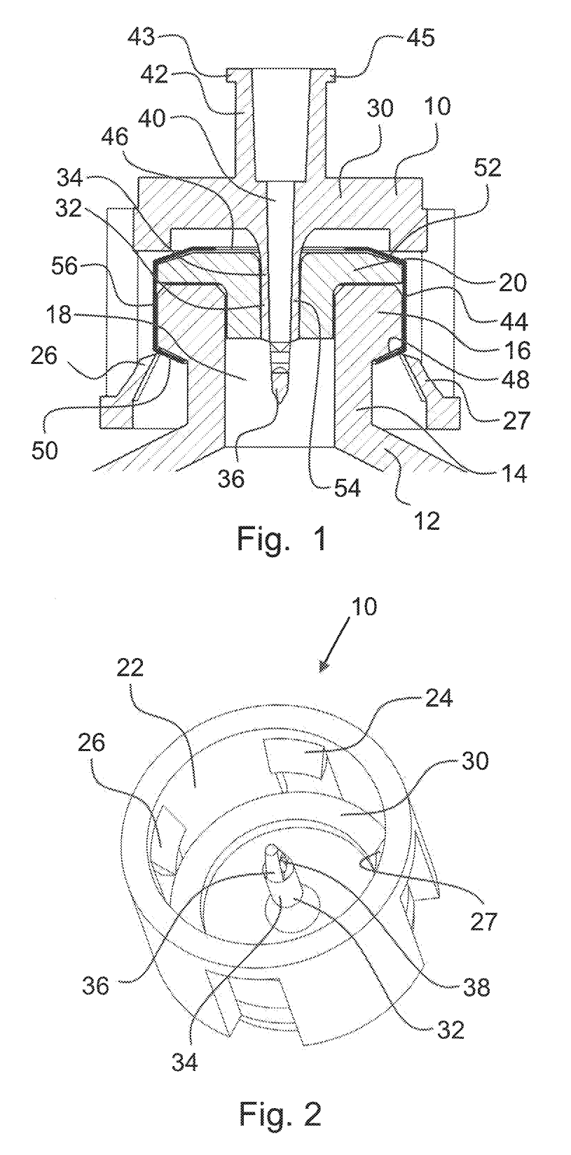

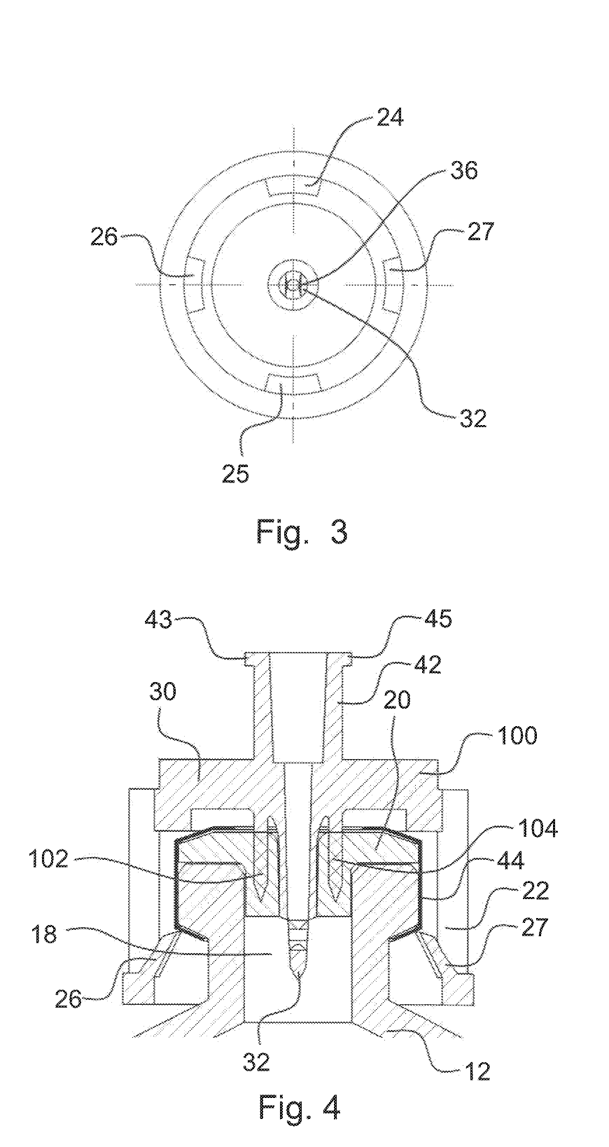

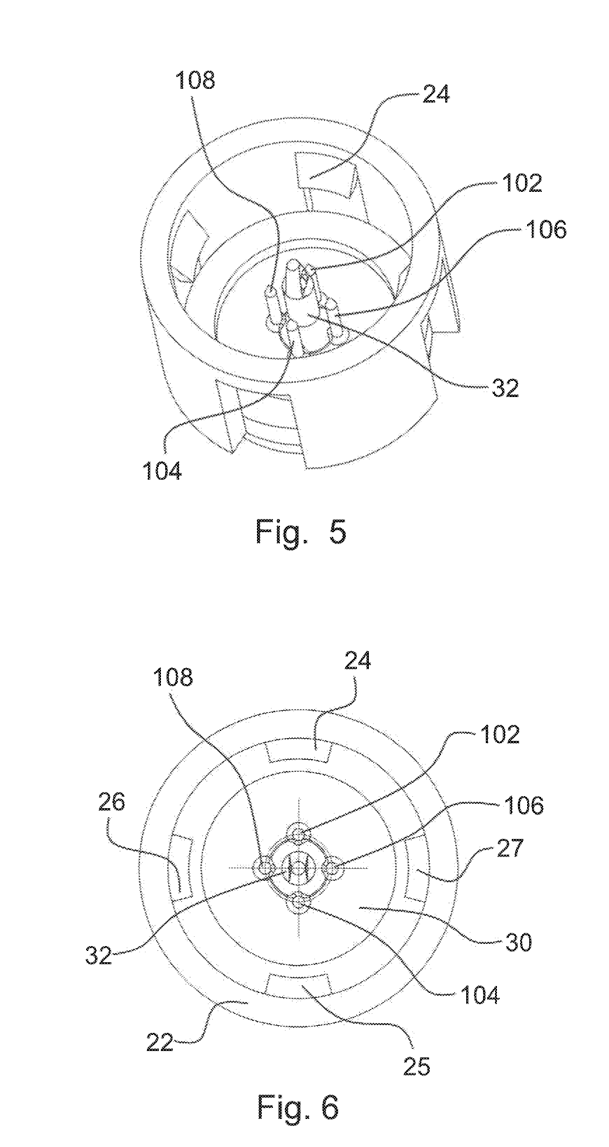

FIGS. 1-3 show in principle a system consisting of an adapter 10 and a first container, in the following also referred to as a bottle such as a vial 12, as configured according to the prior art.

The bottle 12 – in the following generally referred to as vial – has a bottleneck 14 with flange-like or bead-like rim 16 enclosing an opening 18, into which a closing stopper 20 is inserted to seal off the interior of the vial 12. The vial 12 may contain for example a medication or a solvent, to be removed using a syringe body or a tube, for example.

To do so, the adapter 10 is used, which has a peripheral wall 22 with engaging projections 24, 25, 26-27 protruding inwards therefrom. The peripheral wall 22 is closed by a wall 30 extending vertical to the longitudinal axis of the adapter 10 and to the envelope thus created by the peripheral wall 22 and having a hollow-cylindrical geometry.

A cannula body 32 usually referred to as a spike, which is enclosed coaxially by the peripheral wall 22, extends from the center of the wall 30. The spike 32 can be designed in one piece with the adapter 10. The adapter 10 usually consists of plastic, such as polypropylene or polycarbonate.

It is however also possible for the spike 32 to consist of metal, for example, and be connected, such as glued or injection-molded, to the adapter 10.

The spike 32 has a cylindrical basic body 34 from which extends a tip 36 with openings 38, 40 in communication with the lumen 40 of the spike 32, via which the medium contained in the vial 12 can be removed.

While the spike 32 protrudes from the wall 30 into the interior of the adapter 10 along its longitudinal axis, a hollow-cylindrical section 42 extends from opposite side of the wall 30, which is in communication with the lumen 40 of the spike 32 and to which is connected, in particular via a screw connection, for example a syringe body, bag or tube, via which the medium removed from the vial 12 flows.

The hollow-cylindrical section 42 is in particular a female luer cone with protruding lobes 43-45, without this limiting the invention. The lobes 43-45 are intended to engage in a thread.

The stopper 20 – also referred to as the closing stopper – is secured using a stopper cap 44 – usually referred to as a crimped cap or flanged cap – which has in the center a cutout 46 such that the spike 32 can pierce the stopper 20.

The stopper cap 44 – generally referred to in the following as the crimped cap – encloses on the peripheral side the areas, parallel to the longitudinal axis of the vial 12, of the stopper 20 and of the bead-like rim 16, and extends along the underside 48 of the bead-like rim 16 of the vial 12 with an all-round section 50 bent round in particular by crimping, on which the engaging projections 24, 25, 26-27 rest when the adapter 10 is engaged with the vial 12.

This takes place when the spike 32 has pierced the closing stopper 20. During piercing, the closing stopper 20 is compressed in the direction of the bottom of the vial 12.

After piercing of the stopper 20 and when there is no force acting on the adapter 10, the stopper 20 returns to its initial position. Due to the clearance between the wall 30 and the upper side of the crimped cap 44, the required clamping effect between the adapter 10 and the crimped cap 44 and hence the vial 12 is frequently not achieved. This also permits a tilting movement of the adapter 10 or of the vial 12 relative to its longitudinal axis.

Since the spike 32 is, in its contact area 54 sealingly enclosed by the stopper, designed rotationally symmetrical to the longitudinal axis of the spike 32, in the same way as the outer longitudinal surface 56 of the bead-like rim 16, there is a risk during the rotational movement between the hollow-cylinder-like section 42 and the connecting element, such as a syringe body, tube or bag, that the adapter 10 is rotated relative to the vial when the latter is held firmly, thereby making it more difficult to make the required connection. To permit rotation, the adapter 10 must be fixed by the same hand that grips the vial 12. This does however often create problems with vials of both large and small volumes.

To prevent that, it is provided in accordance with the invention that the system made up of adapter and bottle, or the adapter, are designed such that they are arranged in a manner preventing rotation relative to one another, i.e. the adapter enables rotation prevention.

The adapter and bottle form a unit after the stopper of the bottle has been pierced by the cannula body and are not rotatable relative to one another.

There are a number of possibilities for achieving rotation prevention, which take the form of changes to the adapter and/or to the stopper cap in divergence from the previously described prior art.

While the teachings in accordance with the invention are explained in the following using examples in which the adapter has the same general structure as that in FIGS. 1 – 3, the teachings in accordance with the invention are however not limited as a result. Instead, adapters may also be designed in such a way that there is no peripheral wall enclosing the stopper cap on the peripheral side.

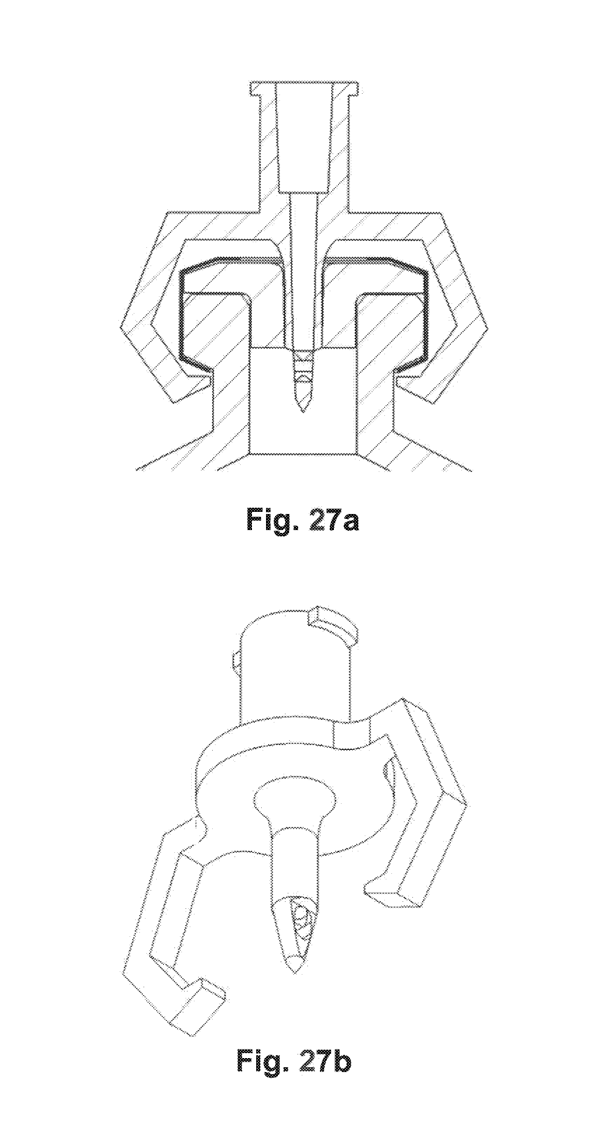

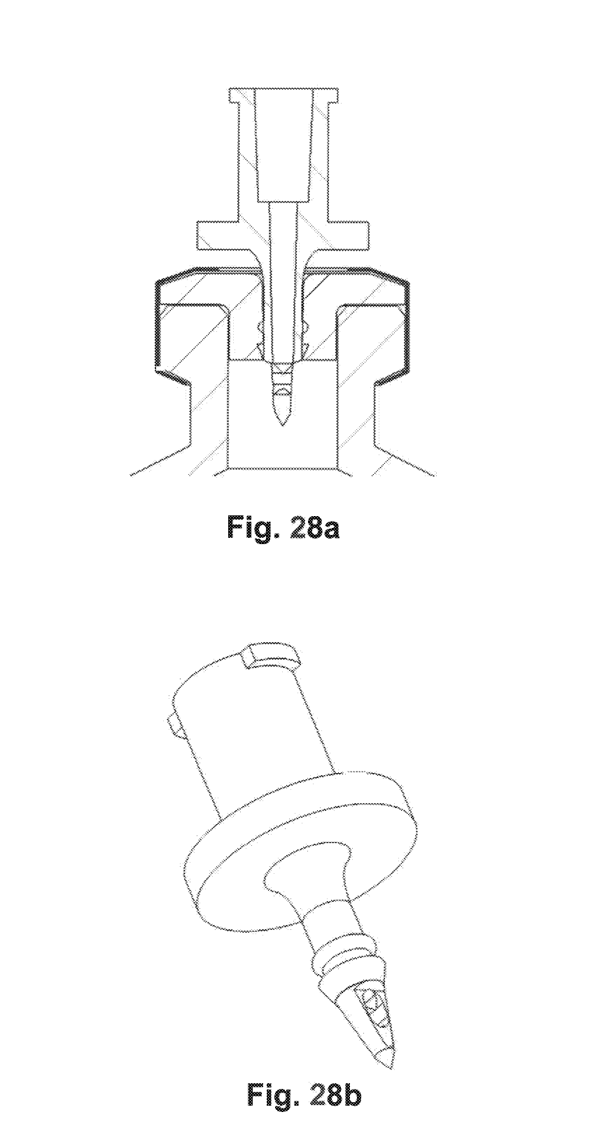

FIGS. 27a, 27b and 28a-28b show, by way of example and purely in principle, adapters 700-800 which may also be designed in accordance with the invention. The adapter 700 according to FIGS. 27a-27b thus has, corresponding to the examples in further embodiments, a wall 30 from whose one side extends a spike 32 and on the opposite side a hollow-cylindrical section 42 such as a luer cone with lobes 43-45. The wall 30 extends beyond the opening 18 of the vial 12 and the rim 16 enclosing it. Finger-like engaging elements 702-704 which grip around the bead-like rim 16 when the adapter 700 is connected to the vial 12, thereby permitting fixing of the adapter 700, extend from the wall 30. Two engaging elements or fingers 702-704 are present in the example.

According to the example in FIGS. 28a-28b, the adapter 800 has a wall 830 from which a spike 832 and a hollow-cylindrical section 42 also extend. The wall 830 extends at least beyond the opening 18 and preferably also at least in some areas along the rim 16, enclosing the opening 18, of the vial 12 and may optionally have peripherally an all-round ridge which extends in some sections along the peripheral side of the bead-like rim 16.

In accordance with what is shown in FIGS. 28a-28b, the spike 832 has all-round, such as sawtooth-like, projections 842-844 that basically prevent a withdrawal of the adapter 800 after penetration into the stopper.

A preferred embodiment of the teachings in accordance with the invention is shown as a first embodiment in FIGS. 4 – 6. The same reference numerals are generally used for identical elements – as in the further examples – that were also used for explanation of the prior art according to FIGS. 1 – 3.

It should be noted that in the application, the terms cannula body, cannula, spike; stopper cap, crimped cap, flanged cap; and first container, bottle, vial, must be regarded as synonyms and are hence interchangeable.

To ensure in the example prevention of rotation between an adapter 100 having the same general structure as the adapter 10 and the vial 12, the spike 32 and the pointed projections 102, 104, 106-108 extending along it, which preferably surround the spike 32 concentrically and are arranged equidistantly to one another, extend from the wall 30 vertical to the longitudinal axis of the adapter 100 and from the peripheral wall 22 parallel to the longitudinal axis of the adapter 10 and having preferably a hollow-cylindrical geometry with the inward-facing engaging projections 24, 25, 26-27. This is also clear from the illustration in FIG. 6.

When the stopper 20 is pierced by the spike 32, the projections 102, 104, 106, 108 also penetrate into the stopper 20. There is also the possibility, diverging from what is shown in the drawing, that the projections 102, 104, 106, 108 pass through the closing stopper 20 completely, i.e. have tips that are below the closing stopper 20.

It is achieved using the projections 102, 104, 106-108 that when an element to be screwed onto the connecting section 42 is rotated, the adapter 100 cannot be co-rotated when the vial 12 is held tight, since the projections 102, 104, 106-108 are fixed in the closing stopper 20, which in turn closes the opening 18 in a press fit.

In addition to rotation prevention, tilting of the adapter 100 relative to the vial 12 is basically also ruled out due to the several projections 102, 104, 106-108 at a distance to the spike 32.

A further result is the advantage that a stronger clamping effect is achieved between the engaging projections 24, 25, 26-27 and the crimped cap 44, since penetration of the spike 32 and of the projections 102, 104, 106-108 into the closing stopper 20 means that the latter is compressed in the direction of the bottom of the vial 12 and hence the adapter 100 undergoes a larger movement relative to the vial 12, and away from the latter, in comparison with the prior art during its resetting to the initial position, since a greater force has to be applied during piercing beforehand in comparison with the prior art, and the closing stopper is thus compressed more strongly.

The projections 102, 104, 106-108 may be designed integral with the adapter 100. There is of course also the possibility that the projections 102, 104, 106-108 are inserts in the adapter 100.

If the projections 102, 104, 106-108 according to FIGS. 4 – 6 are designed as pointed bodies, i.e. conically extending or having a cylindrical basic body with a tip extending therefrom, there is also the possibility to select multi-edge geometries for the projections that penetrate into the closing stopper 20, in order to ensure the previously indicated advantages and in particular rotation prevention.

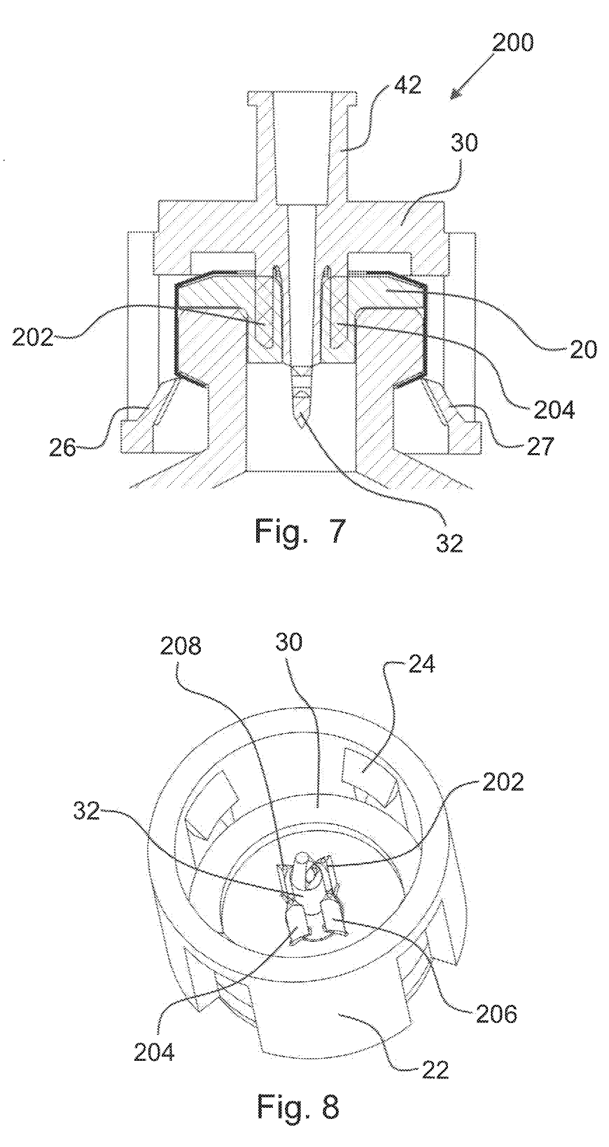

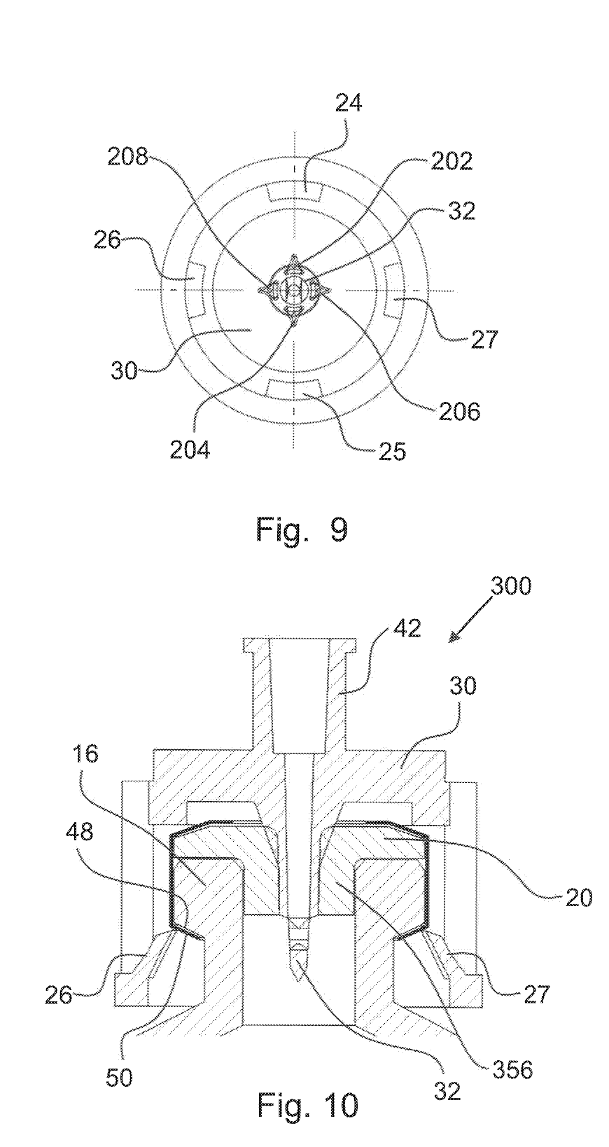

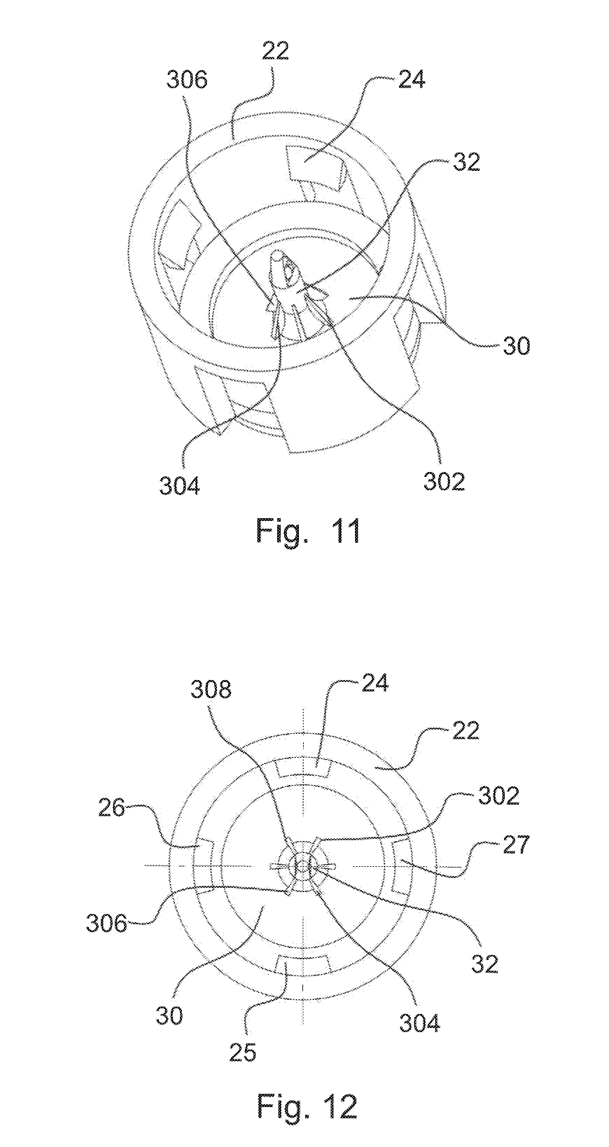

The example of FIGS. 7 – 9 provides a corresponding design. Four three-edged projections 202, 204, 206-208, which are chamfered and pointed at their ends as made clear by FIG. 7, extend from the wall 30 of the adapter 200 in the example. This facilitates penetration into the closing stopper 20.

The projections 202, 204, 206-208 may be designed integral with the adapter 200 or form inserts in the latter.

Irrespectively of this, rotation prevention is assured as a result, by which problem-free connection of the connecting section 42, for example to a syringe body, is enabled by screwing them together, wherein a torque is generated without the adapter being rotated at its longitudinal axis relative to the vial. The advantages with regard to the clamping effect and tilting prevention also apply.

If, according to the embodiments of FIGS. 4 – 9, at least one projection is provided which penetrates into the closing stopper in addition to the spike, the spike 32 can itself also be designed such that rotation prevention is assured by it. To do so, the spike 32 diverges from a circular geometry in its contact area 356 with the closing stopper 20, in which the spike 32 is sealingly enclosed by the closing stopper 20, in some areas in section planes vertical to the longitudinal axis of the spike 32, as FIGS. 10 – 12 make clear.

Radially protruding projections, some of which are identified with the reference numerals 302, 304, 306-308, extend from the spike 32. The projections 302, 304, 306-308 with their outer edges tapering according to the distance starting from the wall 30 in the direction of the longitudinal axis of the spike 32, in effect cut into the closing stopper 20, whereby not only rotation prevention is assured but also the closing stopper 20 is compressed by the force acting on it in order to then enable, when relieved, the required clamping effect between the engaging projections 24, 25, 26-27 and the all-round rim 50 of the crimped cap 44 extending along the underside 48 of the bead-like rim 16.

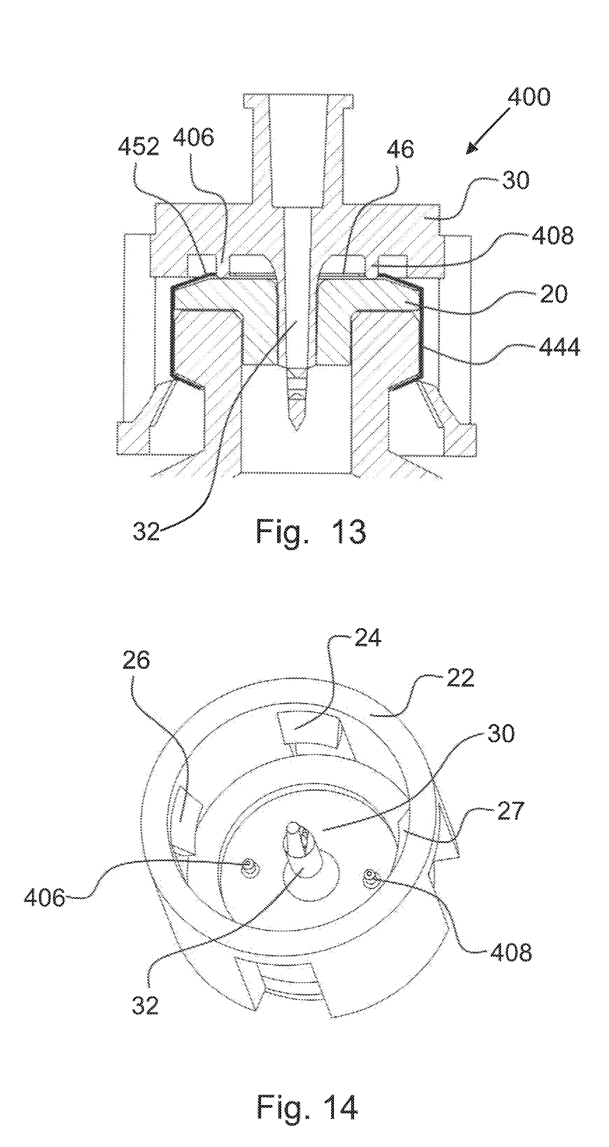

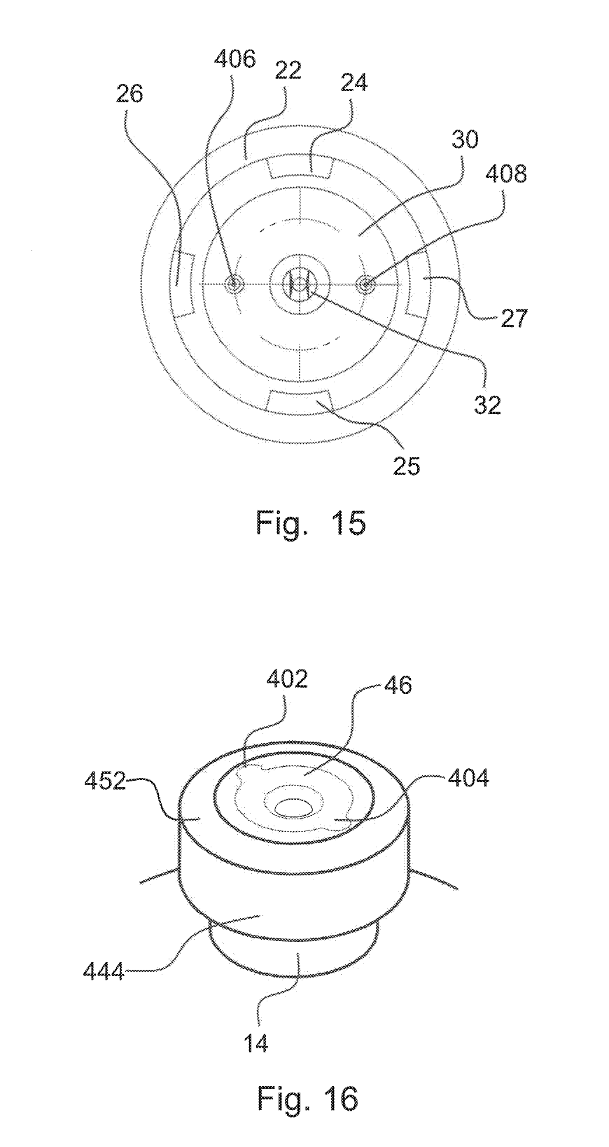

It is however also possible to prevent any rotation between the adapter and the vial by alteration both of the adapter – like the adapter 400 according to FIGS. 13 – 16 – and of the stopper cap 444, i.e. the crimped cap.

The crimped cap 444 thus has, in its rim 452 extending along the upper side of the closing stopper 20, cutouts 402-404 on the rim side into which projections 406- 408 protruding from the wall 30 engage when the spike 32 passes through the closing stopper 20, ensuring non-rotatability.

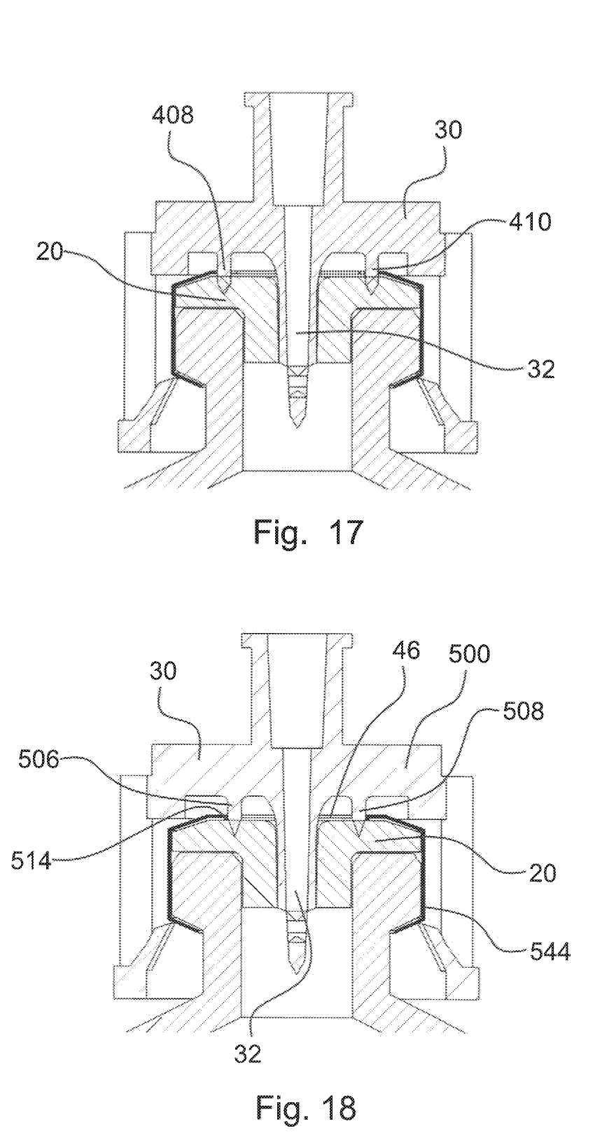

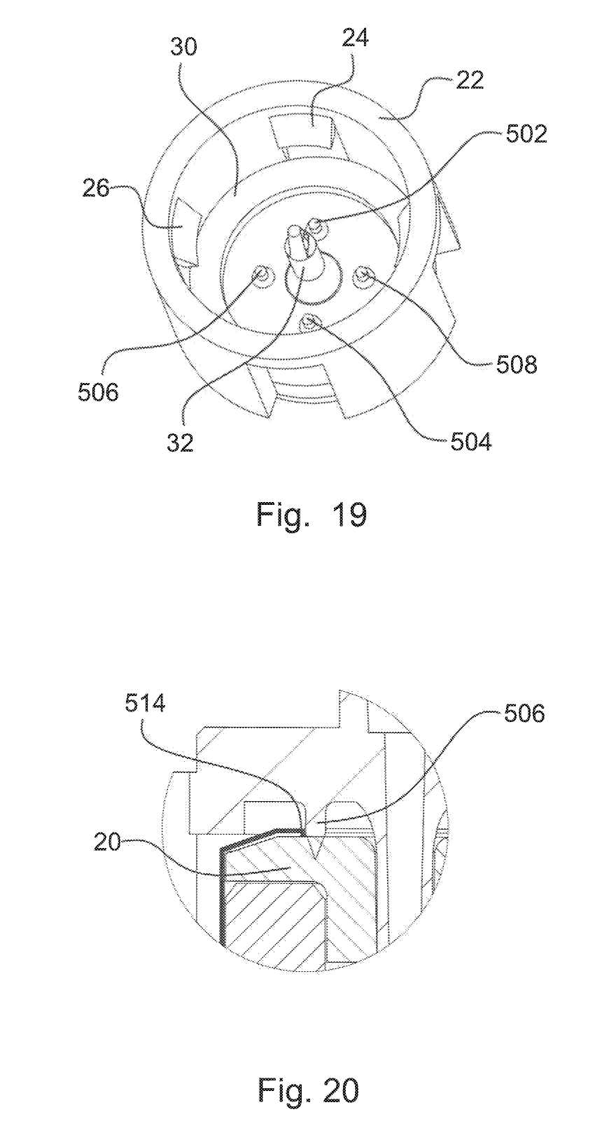

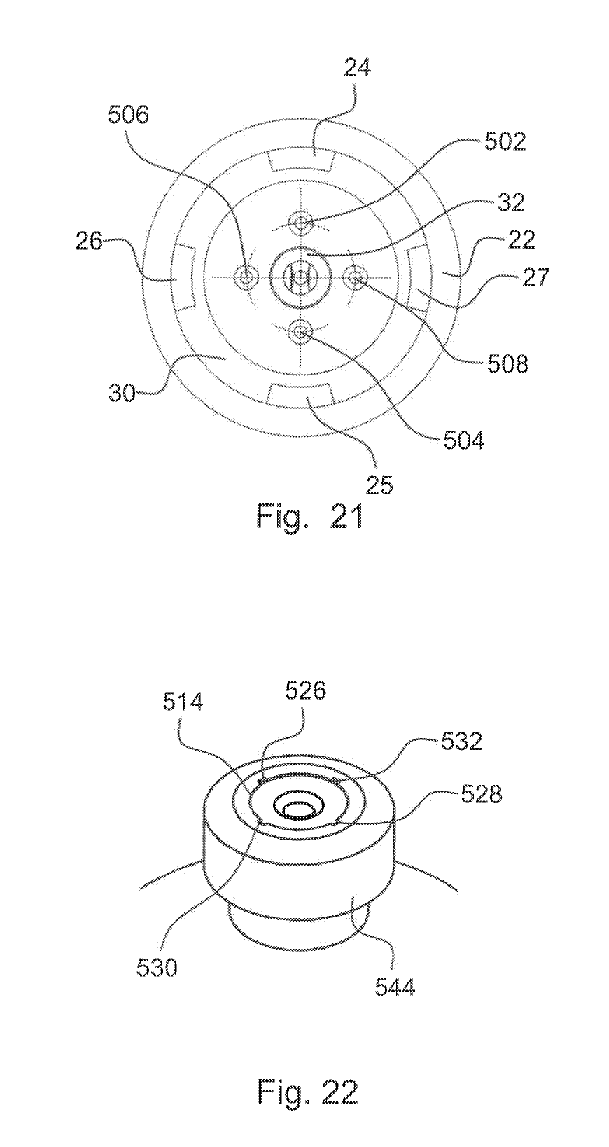

It goes without saying that there is no departure from the invention if the projections 406-408 additionally penetrate into the stopper 20, as FIG. 17 makes clear. The projections 408-410 are for that purpose designed pointed at the ends.

According to the example of FIGS. 18 – 22, an adapter 500 is used to ensure non-rotatability and has projections 502, 504, 506-508 protruding from the wall 30 which cause a reshaping in the crimped cap 544 during penetration of the spike 32 into the closing stopper 20, so that the projections 502, 504, 506-508 can in effect be referred to as shaping or impressing projections. The projections 506, 508, 510-512 are arranged relative to the free inner rim 514 of the crimped cap 544 enclosing the opening 46 such that the rim edge 514 is bent round, as shown from the detail in FIG. 20. The rim edge 514 is bent around in the direction of the closing stopper 20, and in effect digs tightly into the latter.

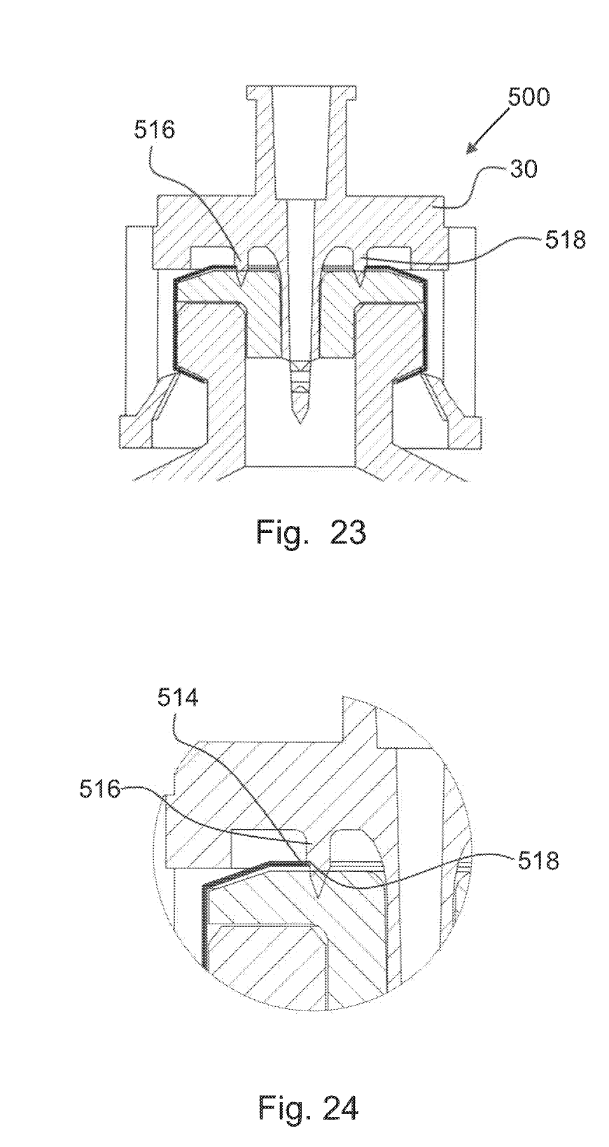

According to FIGS. 23 – 25, the respective projection 516-518 can, alternatively or supplementarily, be shaped depending on the hardness of the materials such that the rim edge 514 penetrates into it, so that a positive connection between the rim edge 514 of the crimped cap 544 and the projections 516-518 is obtained, effectively creating an engagement between them and thereby ensuring rotation prevention. This is made clear in particular by FIG. 24.

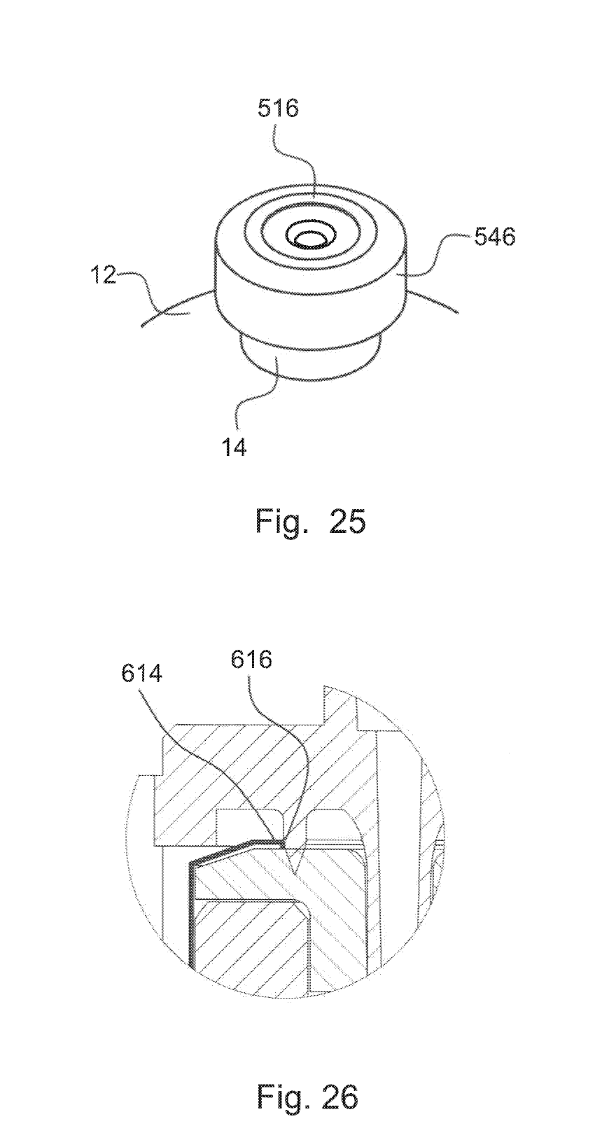

FIG. 25 shows the crimped cap 546 of the example in FIGS. 23 and 24, without the rim edge 514 being reshaped. Instead, the latter has penetrated into the projection 516 protruding from the wall 30 or has reshaped it, such that a step 547 has been formed with which the rim edge 514 is in contact. To that extent, FIGS. 23 – 25 are self-explanatory.

According to FIG. 26, the materials of the projections and of the crimped cap are selected such that shaping of both the inner rim edge 614 and the projection 616 is achieved. To that extent, FIG. 26 represents a combination of the embodiment in FIGS. 18 – 22 on the one hand and FIGS. 23 – 25 on the other.

While the drawing shows that the projections enabling rotation prevention are integral with the wall 30, they can also be separate structural elements which are connected to the wall 30 or to another section of the adapter.

It is also possible that engaging receptacles extending in the longitudinal direction of the vial are formed in the peripheral surface of the crimped cap, where engaging projections extending from the adapter engage in these receptacles, or vice versa.

While the spike is shown to be also designed integral with the adapter or the wall, it may also be a separate part which is connected to the adapter or wall, i.e. by injection molding or adhesion.

In accordance with the invention, it is assured, regardless of the rotationally symmetrical contact area between the spike and the closing stopper when the spike is passing through the stopper, that the adapter is not rotated relative to the vial when the spike has penetrated into the closing stopper and a torque is acting on the adapter.

As already mentioned, the rotation prevention in accordance with the invention is not only intended for embodiments of adapters as shown in FIGS. 4 – 26, but also for other designs of adapters, embodiments of which are shown purely by way of example in FIGS. 27a, 27b and 28a-28b.

What is claimed is:

1. An adapter (100, 200, 300, 400, 500, 700, 800) for transferring a substance from a first container (12) such as a vial having an opening (18) with a rim (16) enclosing it, into a second container such as a syringe body comprising a wall (30, 830) designed to extend along the opening when the adapter is associated with the first container, wherein a cannula body (32) extends from one side of the wall, and a hollow-cylindrical section (42) in communication with the cannula body extends from the other side and is connectable to the second container; wherein the opening of the first container is sealable using a stopper (20) which is pierceable by the cannula body; and wherein the cannula body has a contact area (54) in which the cannula body is sealingly enclosed by the stopper after piercing it, characterized in that that the adapter (100, 200, 300, 400, 500, 700, 800) is designed for rotation-preventing connection to the first container (12).

2. The adapter according to claim 1, characterized in that:
that at least one projection (102, 104, 106, 108, 202, 204, 206, 208) extending along the cannula body (32) and designed to penetrate into the stopper (20) extends from the wall (30, 830), and/or
that the cannula body (32) has a cross-section diverging from a circular geometry in the contact area (54) on the peripheral side in a plane vertical to the longitudinal axis of the cannula, and/or
that, in its contact area (54), at least one projection (302, 304, 306, 308) protruding from the peripheral surface of the cannula body (32) extends, and/orthat the adapter (400) has in its inner peripheral area engaging projections (406, 408) designed to engage in engaging receptacles (402, 404) of a stopper cap (444) enclosing the rim of the first container or vice versa, and/or
that the adapter (500) has at least one shaping or impressing projection (502, 504, 506, 508) designed to form a shape in a stopper cap (44) enclosing the rim (16) of the first container when the first container is gripped.

3. The adapter according to claim 2, characterized in that the at least one projection (102, 104, 106, 108, 202, 204, 206, 208) has a cylindrical geometry with a tip area tapering at the end or at least edges extending in the longitudinal direction, and in particular has a multiple-edge geometry in the longitudinal direction with a tip area tapering at the end.

4. The adapter according to claim 2, characterized in that ridge-like projections (302, 304, 306, 308) designed to penetrate into the stopper extend from the cannula body (132), and in that peripheral rims of the projections at a distance from the cannula are inclined relative to the longitudinal axis of the cannula body, wherein an area close to the cannula tip has a shorter distance from the longitudinal axis of the cannula than an area at a distance from the cannula tip.

5. The adapter according to claim 2, characterized in that the adapter (100, 200) has several pointed projections (102, 104, 106, 108, 202, 204, 206, 208), which are arranged in particular equidistantly to one another, wherein the projections extend preferably from a circle which preferably encloses the cannula body (32) coaxially.

6. The adapter according to claim 2, characterized in that the projection is designed, when the stopper cap is enclosed by the adapter, to be shaped by the stopper cap such that the rim area of the stopper cap extending along the stopper positively engages in the projection.

7. The adapter according to claim 2, characterized in that the at least one shaping or impressing projection (502, 504, 506, 508) protruding from the wall (30) extends preferably in the longitudinal direction of the cannula body (32).

8. The adapter according to claim 2, characterized in that the stopper cap (44) has a circular geometry on the peripheral side in a plane vertical to the longitudinal axis of the bottle and over its entire height and/or in that at least the cannula body (34) has a circular geometry in a plane vertical to the longitudinal axis of the cannula body in the contact area (54) enclosed by the stopper and contacting the latter over the entire length of the contact area.

9. The adapter according to claim 2, characterized in that the cannula body (32) in its contact area (54) sealed by the stopper (20) and the stopper cap (44) have on the peripheral side a geometry rotationally symmetrical to the longitudinal axis of the adapter (100, 200, 300, 400, 500).

10. A system comprising
a first container (12) such as a vial comprising a neck (14) with opening (18), a stopper (20) placed inside the opening, an in particular flange-like or bead-like rim (16) enclosing the opening, and preferably a stopper cap (44) enclosing the rim and covering the stopper on the rim side, and
an adapter (100, 200, 300, 400, 500, 700, 800) comprising a wall, designed to extend along the opening when the adapter is associated with the first container, wherein a cannula body (32) designed to pierce the stopper extends from one side of the wall (30, 830), and a connecting section (42) for a second container such as a syringe body, connected to the cannula body in fluid-carrying manner, extends from its other side,
characterized in that when the adapter (100, 200, 300, 400, 500) is connected to the first container (12) and/or when the adapter (700, 800) is covering the opening (18) of the first container (12), the adapter is connected to the stopper (20) and/or to a stopper cap (44) enclosing the opening of the first container in a manner preventing rotation, or the adapter is prevented from rotation relative to the first container.

11. The system according to claim 10, wherein the adapter preferably has a hollow-cylindrical peripheral wall (22) enclosing and/or gripping around the rim (16) of the opening of the first container (12), which peripheral wall extends from the wall (30) extending vertical to the longitudinal axis of the adapter, characterized in that at least one in particular pointed projection (102, 104, 106, 108, 202, 204, 206, 208) which has penetrated into the stopper (20) when the adapter is enclosing or gripping around the rim (16) of the bottle (12), extends from the adapter (100, 200), in particular from the wall (30).

12. The system according to claim 11, characterized in that the adapter (100, 200) has several pointed projections (102, 104, 106, 108, 202, 204, 206, 208), which are arranged in particular equidistantly to one another, wherein the projections extend preferably from a circle which preferably encloses the cannula body (32) coaxially, and wherein the projections (102, 104, 106, 108, 202, 204, 206, 208) extend along the cannula body (32), preferably parallel or approximately parallel thereto.

13. The system according to claim 11, characterized in that the at least one projection (102, 104, 106, 108) has a cylindrical geometry with a tip area tapering at the end, and/or in that the at least one projection (202, 204, 206, 208) has edges extending in the longitudinal direction, in particular a multiple-edge geometry in the longitudinal direction with tip areas tapering at the end.

14. The system according to claim 10, wherein the cannula body (32) has a contact area (356) sealed by the stopper (20) when the adapter (300) is enclosing the bottle (14), characterized in that the contact area (356) diverges at least in some areas from a circular geometry in a plane vertical to the longitudinal axis of the cannula body (32).

15. The system according to claim 10, characterized in that ridge-like projections (302, 304, 306, 308), whose peripheral rims at a distance from the cannula are inclined relative to the longitudinal axis of the cannula body (32), extend from the cannula body (32), wherein an area close to the cannula tip has a shorter distance from the longitudinal axis of the cannula body than an area at a distance from the cannula tip.

16. The system according to claim 10, characterized in that the adapter has, in its area interacting with the stopper cap (44), engaging elements such as ridge-like projections in the longitudinal direction of the adapter, and the stopper cap has in its area interacting with the adapter, such as the peripheral surface, engaging receptacles adapted in some sections, such as channel-like depressions in the longitudinal direction of the bottle, or vice versa.

17. The system according to claim 10, characterized in that the adapter (500) has at least one shaping or impressing projection (502, 504, 506, 508) designed to form, when the stopper cap (44) is gripped, a corresponding shape therein, wherein the shaping or impressing projection engages in that shape when the adapter is enclosing the stopper cap.

18. The system according to claim 10, characterized in that the adapter has at least one projection designed, when the stopper cap is enclosed by the adapter, to be shaped by the stopper cap such that the rim area of the stopper cap extending along the stopper positively engages in the projection.

19. A method for removing a medium from a first container (12) such as a vial with an opening closed by a stopper (20) using an adapter (102, 103, 104, 100, 500, 700, 800) with a wall (30, 38) vertical to its longitudinal axis, from one side of which wall extends a cannula body (32) passing through the stopper and from whose opposite side extends a connecting section (42) for a second container such as a syringe body, characterized by the method steps:
a) piercing of the stopper (20) by means of the cannula body (32),
b) rotation-preventing connection between the adapter (100, 200, 300, 400, 500, 700, 800) and the first container (12),
c) connection of the second container to the connecting section,
d) exerting a torque on the connecting section by means of the second container with simultaneous fixing of the first container.

20. The method according to claim 19, characterized in that the method steps a) and b) and/or the method steps c) and d) are performed simultaneously.
